(19) United States
(12) Patent Application Publication
(10) Pub. No.: US 2017/0120491 A1
(43) Pub. Date: May 4, 2017

(54) MANUFACTURING APPARATUS FOR COMPOSITE OPTICAL ELEMENT AND MANUFACTURING METHOD FOR COMPOSITE OPTICAL ELEMENT

(71) Applicant: OLYMPUS CORPORATION, Tokyo (JP)

(72) Inventor: Kazuhiro KIKUMORI, Kamiina-gun (JP)

(73) Assignee: OLYMPUS CORPORATION, Tokyo (JP)

(21) Appl. No.: 15/408,654

(22) Filed: Jan. 18, 2017

Related U.S. Application Data
(63) Continuation of application No. PCT/JP2015/066214, filed on Jun. 4, 2015.

(30) Foreign Application Priority Data
Jul. 28, 2014 (JP) 2014-153283

(51) Int. Cl. B29C 45/16; G02B 3/06; B29D 11/00

(52) U.S. Cl. CPC B29C 45/16; B29D 11/00; G02B 3/06

(57) ABSTRACT

A manufacturing apparatus for a composite optical element includes a first cavity portion which molds a first optical element portion partly having a first optical function surface with the first molding material, and a second cavity portion which molds a second optical element portion that is provided on the first optical element portion to cover the first optical function surface with a second molding material, and integrates the second optical element portion with the first optical element portion, whereby mold the composite optical element. The manufacturing apparatus includes a discharge opening portion in which a discharge direction of the second molding material from a supply path portion to the second cavity portion is along the first optical function surface.

### CROSS-REFERENCE TO RELATED APPLICATIONS

This application is a Continuation Application of PCT Application No. PCT/JP2015/066214, filed Jun. 4, 2015 and based upon and claiming the benefit of priority from prior Japanese Patent Application No. 2014-153283, filed Jul. 28, 2014, the entire contents of all of which are incorporated herein by reference.

### BACKGROUND OF THE INVENTION

1. Field of the Invention

The present invention relates to a manufacturing apparatus for a composite optical element and a manufacturing method for a composite optical element.

2. Description of the Related Art

For example, Jpn. Pat. Appln. KOKAI Publication No. 3-248824 discloses a molding method and a molding die to mold a composite optical element by double molding. This composite optical element is molded by joining two optical element portions to each other.

In the above composite optical element, a first optical element portion is molded with a first molding material having melting properties in primary molding, and a second optical element portion is molded with a second molding material having melting properties in secondary molding. The first optical element portion has a first optical function surface provided on an outer circumferential surface of the first optical element portion. In the secondary molding, the second optical element portion covers the first optical function surface and further joins to the first optical function surface, whereby the second optical element portion is integrated with the first optical element portion, and the composite optical element is molded.

For the composite optical element to ensure desired optical performance, the state of the first optical function surface and the state of an inner circumferential surface of the second optical element portion which function as joint surfaces are important. Generally, if the first molding material and the second molding material melt and solidify together in their boundary part, the first optical element portion is integrated with the second optical element portion. Thus, the melting state and solidification state considerably affect the state of the first optical function surface, and therefore considerably affect the optical performance of the composite optical element. For example, the optical performance deteriorates if the first optical function surface is deformed by melting or if junction is uneven.

According to Jpn. Pat. Appln. KOKAI Publication No. 3-248824, in the secondary molding, the second molding material is discharged toward the first optical function surface from a pin gate along a direction which is substantially perpendicular to the first optical function surface of the first optical element portion.

### BRIEF SUMMARY OF THE INVENTION

A manufacturing apparatus for a composite optical element according to an aspect of the invention includes: a first cavity portion which is configured to be filled with a first molding material, and mold a primary molded article partly having a first optical function surface with the first molding material, in a primary molding process; a second cavity portion which is configured to be filled with a second molding material, configured to mold, with the second molding material, a secondary molded article that is provided on the primary molded article to cover the first optical function surface, and configured to integrate the secondary molded article with the primary molded article, whereby mold the composite optical element, in a secondary molding process; and a discharge opening portion which is provided in a communication part between a supply path portion to supply the second molding material to the second cavity portion and the second cavity portion and in which a discharge direction of the second molding material from the supply path portion to the second cavity portion is along the first optical function surface.

A manufacturing method for a composite optical element according to an aspect of the invention includes: a primary molding process to mold a primary molded article partly having a first optical function surface with a first molding material; and a secondary molding process to discharge a second molding material along the first optical function surface so that the second molding material to mold a secondary molded article flows along the first optical function surface, mold the secondary molded article that is provided on the primary molded article to cover the first optical function surface, and integrate the secondary molded article with the primary molded article, whereby mold the composite optical element.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1A shows a composite optical element according to a first embodiment of the present invention, and is a sectional view taken along the line 1A-1A shown in FIG. 1B;

FIG. 1B is a bottom view of the composite optical element shown in FIG. 1A;

FIG. 2 is a diagram showing a manufacturing apparatus to a manufacture the composite optical element shown in FIG. 1A, and a diagram showing a state where a movable die is closed relative to a first fixed die, and a first optical element portion is molded;

FIG. 3 is a diagram showing a state where the movable die has opened relative to the first fixed die from the state shown in FIG. 2;

FIG. 4 is a diagram showing a state where a movable platen has rotated from the state shown in FIG. 3, a movable die which holds the first optical element portion faces a second fixed die, and a movable die which does not hold the first optical element portion faces the first fixed die;

FIG. 5 is a diagram showing a state where the movable die is closed relative to the first fixed die from the state shown in FIG. 4 and the first optical element portion is molded, and is a diagram showing a state where the movable die is closed relative to the second fixed die and a second optical element portion is molded;

FIG. 6 is an enlarged view of parts around a second discharge opening portion including the second discharge opening portion in a second molding die shown in FIG. 5;

FIG. 7 is a diagram showing a state where the movable die has opened relative to the first fixed die from the state shown in FIG. 5, and is a diagram showing a state where the movable die has opened relative to the second fixed die;

FIG. 8 is a diagram showing a state where the composite optical element has been taken out from the state shown in FIG. 7;

FIG. 9A is a sectional view showing a state where more than one second discharge opening portion are provided, and taken along the line 9A-9A shown in FIG. 9B;

FIG. 9B is a bottom view of parts around the second discharge opening portions including the second discharge opening portions shown in FIG. 9A;

FIG. 10A is a diagram showing the composite optical element according to a second embodiment of the present invention;

FIG. 10B is a diagram simply showing a manufacturing apparatus to manufacture the first optical element portion of the composite optical element shown in FIG. 10A; and

FIG. 10C is a diagram simply showing a manufacturing apparatus to manufacture the second optical element portion of the composite optical element shown in FIG. 10A.

### DETAILED DESCRIPTION OF THE INVENTION

Hereinafter, embodiments of the present invention will be described in detail with reference to the drawings.

### First Embodiment

[Configuration]

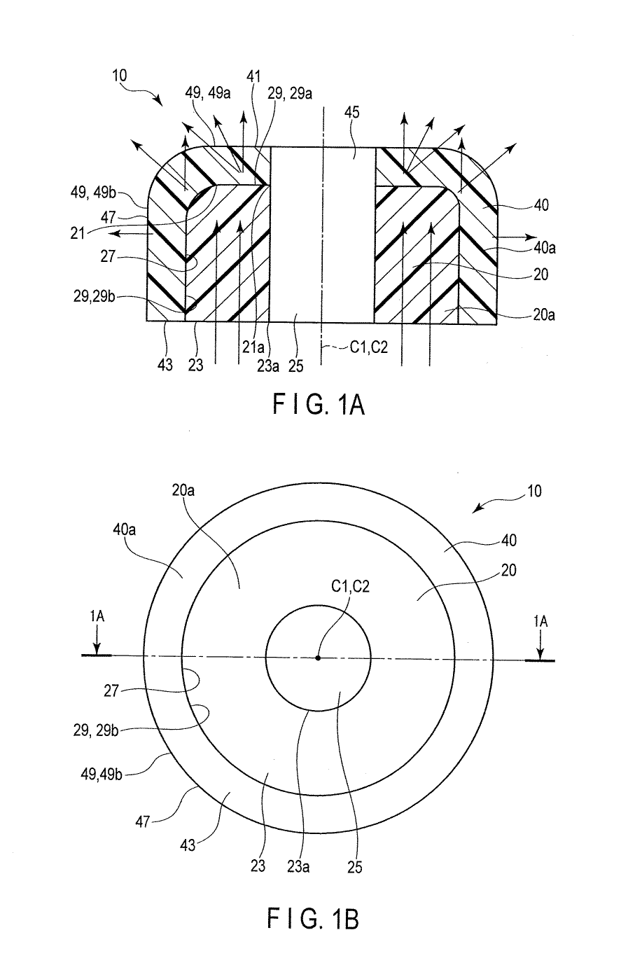

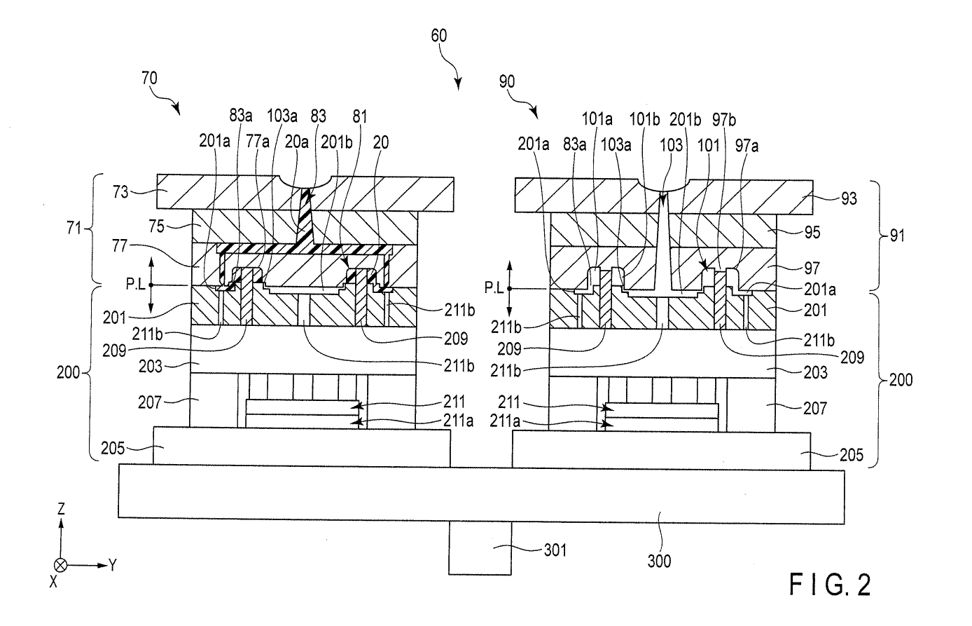

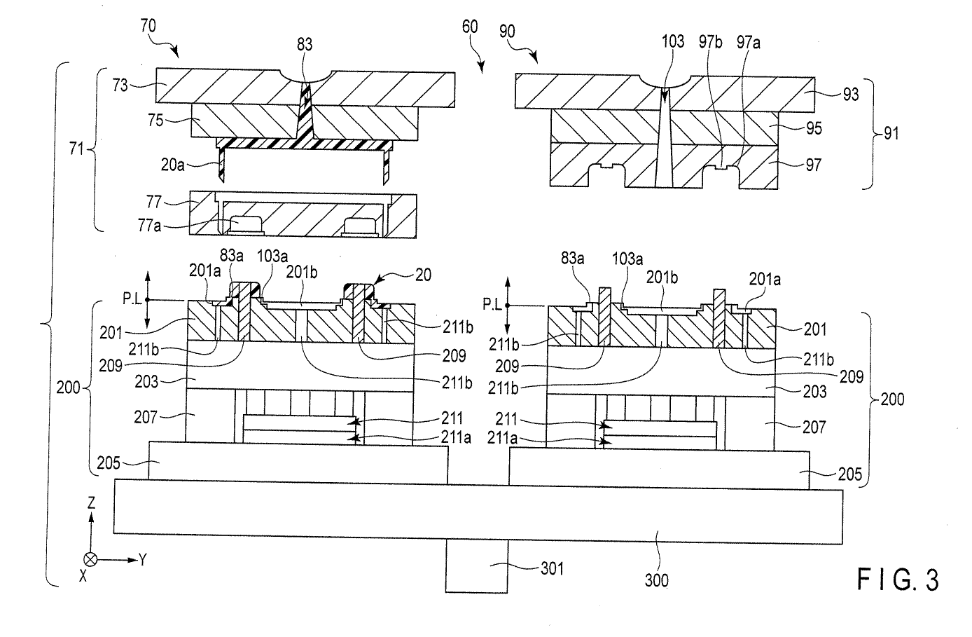

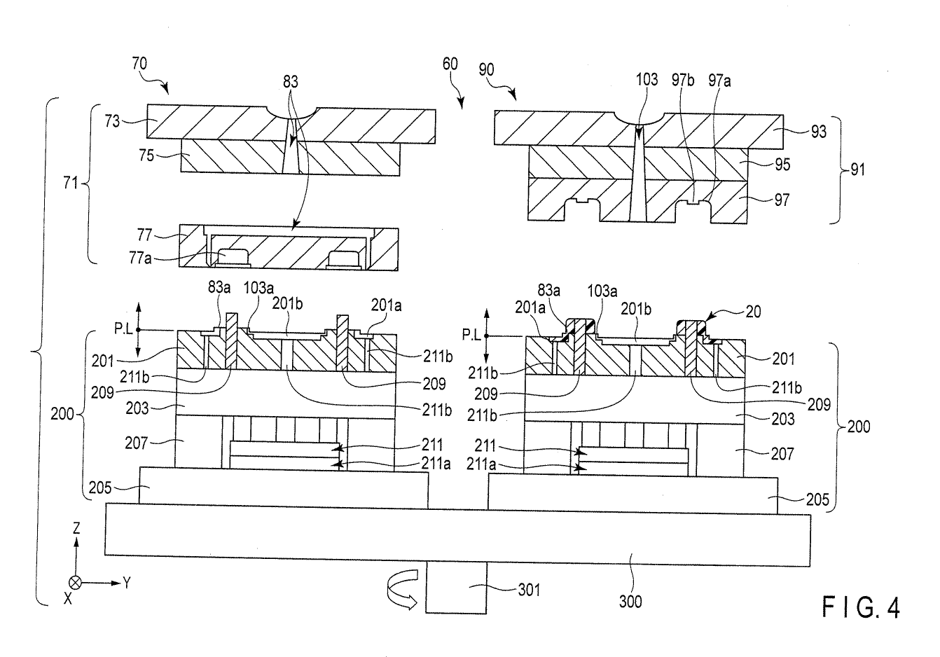

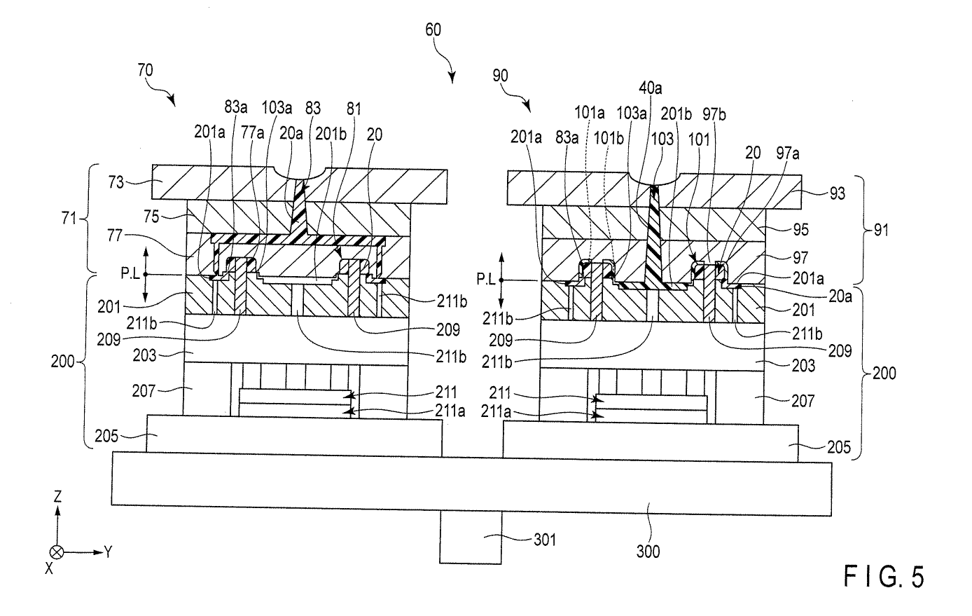

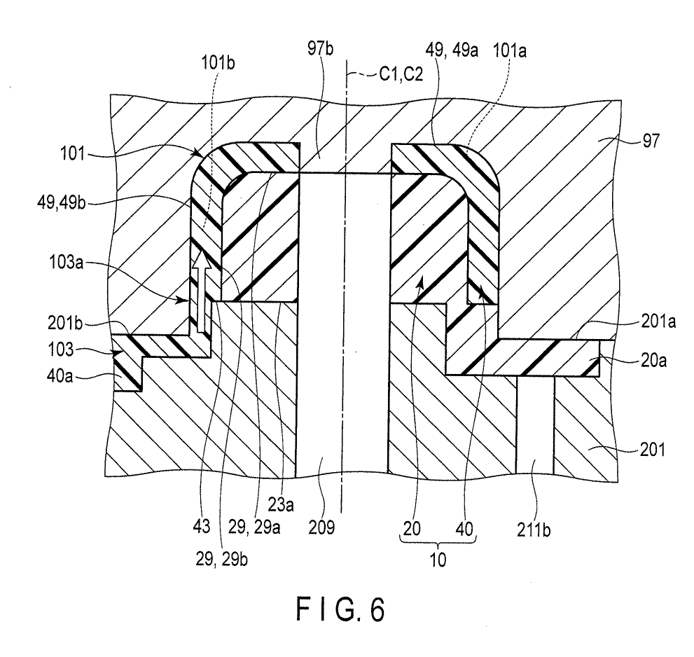

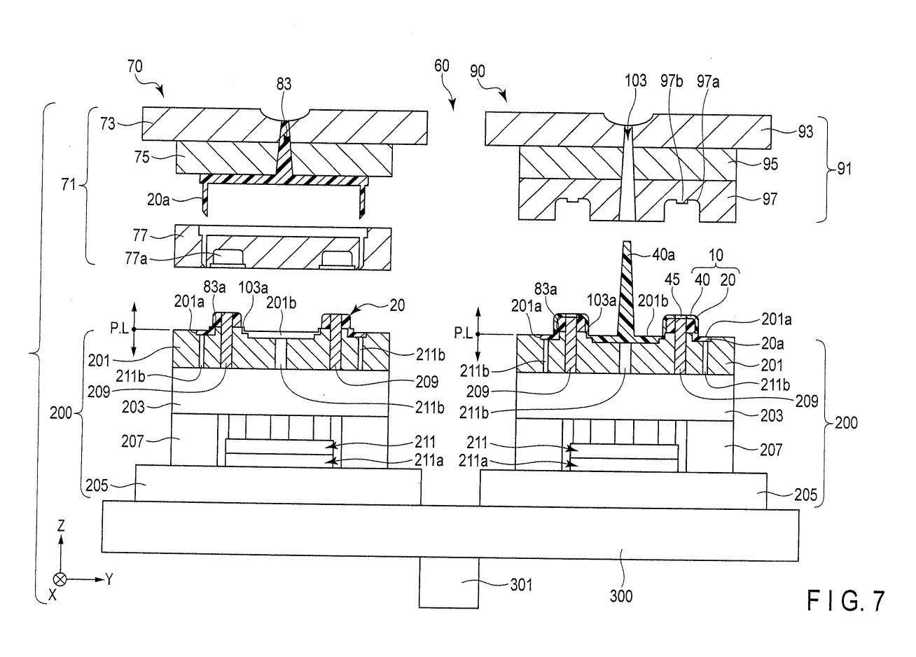

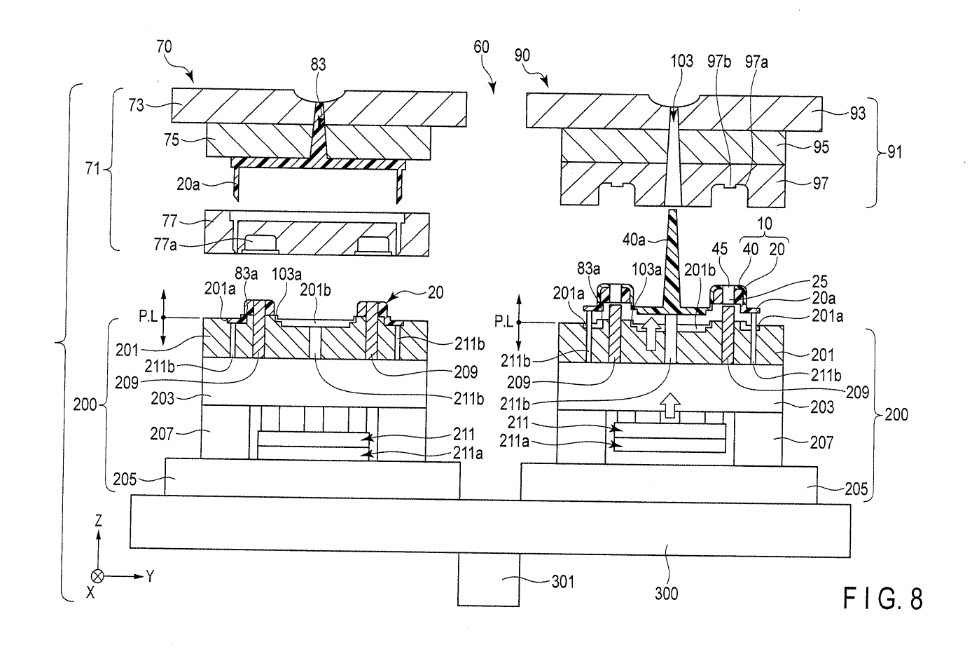

The first embodiment is described with reference to FIG. 1A, FIG. 1B, FIG. 2, FIG. 3, FIG. 4, FIG. 5, FIG. 6, FIG. 7, and FIG. 8. Some components are not shown in some of the drawings for the clarification of diagramatic representation.

[Composite Optical Element 10]

A composite optical element 10 shown in FIG. 1A and FIG. 1B is injection-molded by a later-described manufacturing apparatus 60. This composite optical element 10 includes optical components such as a lens for illumination.

The composite optical element 10 has a first optical element portion 20 which is a primary molded article molded with a first molding material 20a in primary molding, and a second optical element portion 40 which is a secondary molded article molded with a second molding material 40a in secondary molding.

The first molding material 20a has, for example, optical characteristics such that light transmits through the first molding material 20a. This first molding material 20a is, for example, a transparent resin material. The first molding material 20a has melting properties.

The optical characteristics of the second molding material 40a are different from the optical characteristics of the first molding material 20a. The second molding material 40a has, for example, the optical characteristics that diffuse light. This second molding material 40a has, for example, a diffusion material, and a transparent resin material which embraces the diffusion material in a state where the diffusion material is scattered. The second molding material 40a is not transparent due to the diffusion material, and becomes colored. The diffusion material has, for example, titanium oxide particles. The second molding material 40a has melting properties.

This composite optical element 10 is formed after the first optical element portion 20 that is molded with the first molding material 20a in the first molding is covered with the second molding material 40a in the second molding and then the first optical element portion 20 is integrated with the second molding material 40a in the second molding. In other words, the composite optical element 10 has the first optical element portion 20 which is a transparent part provided on an inner side of the composite optical element 10 and which is molded first, and the second optical element portion 40 which is an no-transparent (colored) part provided on an outer side of the composite optical element 10 and which is molded after the first optical element portion 20. The composite optical element 10 is a double-color molded article.

In the composite optical element 10, light transmits through the first optical element portion 20, is guided by the first optical element portion 20, and enters the second optical element portion 40. The light is then diffusely emitted to an outside of the composite optical element 10 by the second optical element portion 40.

[First Optical Element Portion 20]

As shown in FIG. 1A and FIG. 1B, the first optical element portion 20 according to the present embodiment has, for example, a cylindrical shape. Thus, the first optical element portion 20 has a first front end face 21 and a first back end face 23. The first optical element portion 20 has a first through-hole 25 which is provided along an axial direction C1 of the first optical element portion 20 and which pierces through the first optical element portion 20, and a first outer circumferential surface 27.

The first through-hole 25 is open in the first front end face 21 and the first back end face 23. In other words, because the first through-hole 25 is provided, the first front end face 21 has a first front end opening portion 21a, and the first back end face 23 has a first back end opening portion 23a. The first front end face 21 is a plane provided along a direction that orthogonally intersects with the axial direction C1 of the first optical element portion 20. The first front end face 21 has, for example, a ring shape because the first front end opening portion 21a is provided. The first back end face 23 has, for example, a ring shape because the first back end opening portion 23a is provided. The first back end face 23 functions as an entrance surface through which light enters the first optical element portion 20. The first through-hole 25 functions as, for example, a housing portion which houses an unshown image pickup device (for example, CCD) of an unshown imaging optical system. The first outer circumferential surface 27 is a plane provided along the axial direction C1 of the first optical element portion 20. The first front end face 21 and the first outer circumferential surface 27 are continuous with each other, and the continuous part is formed as a smooth curved surface.

The first optical element portion 20 has a first optical function surface 29 provided in a part of the outer surface of the first optical element portion 20. The first optical function surface 29 includes the first front end face 21, the first outer circumferential surface 27, and the aforementioned continuous part of the first front end face 21 and the first outer circumferential surface 27. The first optical function surface 29 has a first distal function surface 29a which is provided in the first front end face 21 and which emits forward the light that enters the first optical element portion 20, and a first outer circumferential function surface 29b which is provided in the first outer circumferential surface 27 of the first optical element portion 20 and which emits sideward the light that enters the first optical element portion 20.

The first distal function surface 29a functions as, for example, the whole first front end face 21. Thus, the first distal function surface 29a is a plane and is, for example, ring-shaped like the first front end face 21. The first outer circumferential function surface 29b functions as, for example, the whole first outer circumferential surface 27. The first outer circumferential function surface 29b is a plane like the first outer circumferential surface 27. The first front end face 21 and the first outer circumferential surface 27 are continuous with each other, and the first distal function surface 29a is therefore continuous with the first outer circumferential function surface 29b. The continuous part of the first front end face 21 and the first outer circumferential surface 27 is formed as a smooth curved surface, and the continuous part of the first distal function surface 29a and the first outer circumferential function surface 29b is therefore formed as a smooth curved surface.

Light enters the first optical element portion 20 from the first back end face 23, and transmits through a thick portion of the first optical element portion 20. The light is then emitted to the outside from the first optical function surface 29. In this instance, the first optical function surface 29 emits forward, from the first distal function surface 29a, the light that enters the first optical element portion 20, and emits sideward, from the first outer circumferential function surface 29b, the light that enters the first optical element portion 20. The first optical function surface 29 emits the light forward and sideward from the continuous part.

[Second Optical Element Portion 40]

As shown in FIG. 1A and FIG. 1B, the second optical element portion 40 covers the first optical function surface 29 of the first optical element portion 20 in a domed shape. Specifically, the second optical element portion 40 is stacked on the first optical function surface 29 and further covers the entire first optical function surface 29 so that the first front end opening portion 21a, the first back end opening portion 23a, and the first back end face 23 are exposed to the outside. Thus, a later-described second optical function surface 49 does not block the first front end opening portion 21a and the first back end opening portion 23a.

The second optical element portion 40 has a second front end face 41, and a second back end face 43 provided flush with the first back end face 23. The second optical element portion 40 has a second through-hole 45 which is provided along an axial direction C2 of the second optical element portion 40 and which communicates with the first front end opening portion 21a and which pierces through the second optical element portion 40, and a second outer circumferential surface 47.

The second through-hole 45 is open in the second front end face 41 and an inner circumferential surface of the second optical element portion 40. The second through-hole 45 communicates with the outside and the first through-hole 25. The second through-hole 45 has substantially the same size as the first through-hole 25. The second through-hole 45 functions as, for example, a housing portion which houses an unshown lens of the imaging optical system. The second front end face 41 is a plane provided along a direction that orthogonally intersects with the axial direction C2 of the second optical element portion 40. The second front end face 41 has, for example, a ring shape because the second through-hole 45 is provided. The second outer circumferential surface 47 is a plane provided along the axial direction C2 of the second optical element portion 40. The second front end face 41 and the second outer circumferential surface 47 are continuous with each other, and the continuous part is formed as a smooth curved surface.

As shown in FIG. 1A, the inner circumferential surface of the second optical element portion 40 is stacked on the first optical function surface 29, and is fixed to the first optical function surface 29 by joining. The inner circumferential surface of the second optical element portion 40 and the first optical function surface 29 function as joint surfaces which join the first optical element portion 20 to the second optical element portion 40. The shape of the inner circumferential surface of the second optical element portion 40 is substantially the same size as the shape of the first optical function surface 29. The inner circumferential surface of the second optical element portion 40 functions as an entrance surface through which the light emitted from the first optical function surface 29 enters the second optical element portion 40.

As shown in FIG. 1A, the second optical element portion 40 further has the second optical function surface 49 which is provided in a part of an outer surface of the second optical element portion 40. The second optical function surface 49 includes the second front end face 41, the second outer circumferential surface 47, and the aforementioned continuous part of the second front end face 41 and the second outer circumferential surface 47. The second optical function surface 49 has a second distal function surface 49a which is provided in the second front end face 41 and which emits forward the light that enters the first optical element portion 20, and a second outer circumferential function surface 49b which is provided in the second outer circumferential surface 47 of the second optical element portion 40 and which emits sideward the light that enters the first optical element portion 20.

The second distal function surface 49a functions as, for example, the whole second front end face 41. Thus, the second distal function surface 49a is a plane and is, for example, ring-shaped like the second front end face 41. The second outer circumferential function surface 49b functions as, for example, the whole second outer circumferential surface 47. The second outer circumferential function surface 49b is a plane like the second outer circumferential surface 47. The second front end face 41 and the second outer circumferential surface 47 are continuous with each other, and the second distal function surface 49a is therefore continuous with the second outer circumferential function surface 49b. The continuous part of the second front end face 41 and the second outer circumferential surface 47 is formed as a smooth curved surface, and the continuous part of the second distal function surface 49a and the second outer circumferential function surface 49b is therefore formed as a smooth curved surface.

As shown in FIG. 1A, the second distal function surface 49a functions as a first part of the second optical element portion 40 which is stacked on the first distal function surface 29a so that the first front end opening portion 21a that is an opening portion of the first through-hole 25 formed in the first front end face 21 is exposed, and which further emits, to the outside, the light that enters the second optical element portion 40 from the first optical element portion 20. The second outer circumferential function surface 49b functions as a second part of the second optical element portion 40 which is stacked on the first outer circumferential function surface 29b and which further emits, to the outside, the light that enters the second optical element portion 40 from the first optical element portion 20.

Light enters the second optical element portion 40 from the inner circumferential surface of the second optical element portion 40, and transmits through a thick portion of the second optical element portion 40. The light is then emitted to the outside from the second optical function surface 49. In this instance, the second optical function surface 49 emits forward, from the second distal function surface 49a, the light that enters the second optical element portion 40, and emits sideward, from the second outer circumferential function surface 49b, the light that enters the second optical element portion 40. The second optical function surface 49 emits the light forward and sideward in the continuous part.

[Manufacturing Apparatus 60]

Next, the manufacturing apparatus 60 to manufacture the above composite optical element 10 is described with reference to FIG. 2, FIG. 3, FIG. 4, FIG. 5, FIG. 6, FIG. 7, and FIG. 8. In the present embodiment, the manufacturing apparatus 60 manufactures, for example, two composite optical elements 10 in one molding process.

The manufacturing apparatus 60 has a primary molding die 70 to mold the first optical element portion 20 with the first molding material 20a in the primary molding. The manufacturing apparatus 60 has a secondary molding die 90 which molds the second optical element portion 40 on the first optical element portion 20 by injecting the second molding material 40a to the first optical element portion 20, and integrates the first optical element portion 20 with the second optical element portion 40 to mold the composite optical element 10, in the secondary molding conducted after the primary molding. The primary molding die 70 and the secondary molding die 90 are mounted on a movable platen 300 of an injection molding machine. The primary molding die 70 is provided adjacent to the secondary molding die 90 in a Y-direction.

[Primary Molding Die 70 and Secondary Molding Die 90]

As shown in FIG. 2, the primary molding die 70 has a first fixed die 71, and a movable die 200 provided to face the first fixed die 71 across a parting line (hereinafter referred to as a “PL”).

The secondary molding die 90 has a second fixed die 91, and a movable die 200 provided to face the second fixed die 91 across a PL.

The movable die 200 facing the first fixed die 71 has the same configuration as the movable die 200 facing the second fixed die 91. Thus, the movable dies 200 are shared by the primary molding die 70 and the secondary molding die 90.

As shown in FIG. 2 and FIG. 3, the two movable dies 200 are supported by the movable platen 300 so that one movable die 200 is movable relative to the first fixed die 71 in an open/close direction and another movable die 200 is movable relative to the second fixed die 91 in the open/close direction at the same time. The open/close direction indicates an up-down direction (Z-direction) in FIG. 2. The Z-direction orthogonally intersects with the Y-direction. That is, the movable dies 200 can be in and out of contact with the first fixed die 71 and the second fixed die 91 at the same time.

As shown in FIG. 4, when the movable platen 300 rotates around a rotation shaft 301 of the movable platen 300, the movable dies 200 supported by the movable platen 300 rotate around the rotation shaft 301 of the movable platen 300. Accordingly, the movable dies 200 face the first fixed die 71 or the second fixed die 91. The rotation shaft 301 of the movable platen 300 is provided along the open/close direction.

[Primary Molding Die 70]

As shown in FIG. 2, the primary molding die 70 has, for example, two first cavities 81 which are formed between the first fixed die 71 and the movable die 200 in the open/close direction when the movable die 200 is closed relative to the first fixed die 71. The primary molding die 70 has a first supply path portion 83 which is provided in the first fixed die 71 and the movable die 200 and which functions as a flow path portion where the first molding material 20a flows and which communicates with the first cavities 81 and which allows the first molding material 20a to flow to the first cavities 81.

As shown in FIG. 2, the first cavities 81 are formed to mold the first optical element portions 20 when the movable die 200 is closed relative to the first fixed die 71. The first cavities 81 are formed as space portions which define the shapes of the first optical element portions 20. The first supply path portion 83 is provided so that the first molding material 20a is supplied to two first cavities 81 from the first supply path portion 83 at the same time.

As shown in FIG. 2, the first molding material 20a is supplied to the first cavities 81 from the first supply path portion 83 and fills the first cavities 81 in a state where the movable die 200 is closed relative to the first fixed die 71 and the first cavities 81 are formed. Pressure holding and cooling are conducted in a state where the movable die 200 is closed relative to the first fixed die 71, and the first optical element portion 20 is molded.

As shown in FIG. 1A and FIG. 2, the above first cavity portion 81 can be filled with the first molding material 20a, and molds the first optical element portion 20 partly having the first optical function surface 29 with the first molding material 20a, in a primary molding process.

As shown in FIG. 1A and FIG. 2, the first cavity portion 81 functions as a moldable space portion for the first optical element portion 20 so that the first optical element portion 20 has the first front end face 21, the first back end face 23, the first through-hole 25, and the first outer circumferential surface 27 and so that the first optical function surface 29 has the first distal function surface 29a and the first outer circumferential function surface 29b.

A specific structure of the primary molding die 70 including the first cavity portion 81 and the first supply path portion 83 is described below.

As shown in FIG. 2, the first fixed die 71 has a primary fixed attachment plate 73 which is fixed to a fixed platen of the unshown injection molding machine, and a primary fixed fall plate 75 which is attached to the primary fixed attachment plate 73 in a state where the primary fixed fall plate 75 is mounted on the primary fixed attachment plate 73. The first fixed die 71 has a primary fixed die plate 77 which is attached to the primary fixed fall plate 75 in a state where the first fixed die 71 is mounted on the primary fixed fall plate 75 and which faces a movable die plate 201 of the movable die 200.

As shown in FIG. 2, the primary fixed die plate 77 has, for example, two first recess portions 77a to mold the first optical element portions 20. Specifically, the first recess portion 77a defines, in the first optical element portion 20, the first front end face 21 including the first distal function surface 29a, the first outer circumferential surface 27 including the first outer circumferential function surface 29b, and the thick portion of the first optical element portion 20. A shape of an inner circumferential surface of the first recess portion 77a corresponds to a shape of the first front end face 21 and a shape of the first outer circumferential surface 27. A circumference of a bottom portion of the first recess portion 77a is formed as a smooth curved surface.

As shown in FIG. 2, the first recess portions 77a are parts of the primary fixed die plate 77 which are recessed toward the primary fixed attachment plate 73 from the movable die plate 201. Thus, the first recess portions 77a are open toward the movable die plate 201. The first recess portions 77a communicate with the first supply path portion 83.

As shown in FIG. 2, the movable die 200 has the movable die plate 201 which faces the primary fixed die plate 77, a movable backing plate 203 on which the movable die plate 201 is mounted, and a movable attachment plate 205 supported by the movable platen 300. The movable die 200 has a spacer block 207 which intervenes between the movable backing plate 203 and the movable attachment plate 205 and which is a regulation member to regulate the ejector amount of a later-described ejector mechanism 211. The movable die 200 has a movable insert portion 209 provided inside the movable die plate 201, and the ejector mechanism 211 which ejects the first optical element portion 20 toward the movable die 200 when the movable die 200 opens relative to the first fixed die 71.

As shown in FIG. 2, the movable die plate 201 and the first recess portions 77a form the first cavities 81 when the movable die 200 is closed relative to the first fixed die 71.

As shown in FIG. 2, the movable insert portion 209 is inserted into the first recess portion 77a so that a distal end face of the movable insert portion 209 abuts on the bottom portion of the first recess portion 77a when the movable die 200 is closed relative to the first fixed die 71. The movable insert portion 209 molds the first through-hole 25 including the first front end opening portion 21a and the first back end opening portion 23a.

As shown in FIG. 2, the ejector mechanism 211 has an ejector plate unit 211a provided inside the spacer block 207, and ejector pin portions 211b. Although not shown, the ejector pin portions 211b are coupled to the ejector plate unit 211a.

As shown in FIG. 2, the ejector plate unit 211a is provided between the movable backing plate 203 and the movable attachment plate 205 in the open/close direction, and is movable in the open/close direction. The ejector plate unit 211a is provided, for example, in a state of a flat plate.

As shown in FIG. 2, proximal end portions of the ejector pin portions 211b are fixed to the ejector plate unit 211a. The ejector pin portions 211b are provided along the open/close direction. The ejector pin portions 211b are then inserted into the movable backing plate 203 and the movable die plate 201.

As shown in FIG. 2, the first cavities 81 are formed by, for example, the first recess portions 77a and the movable die plate 201 when the movable die 200 is closed relative to the first fixed side.

As shown in FIG. 2, the first supply path portion 83 is provided inside the primary fixed attachment plate 73, the primary fixed fall plate 75, the primary fixed die plate 77, and the movable die plate 201, and is formed as a hole provided in these parts. In the movable die plate 201, the first supply path portion 83 is formed when an outer movable recess portion 201a provided in the movable die plate 201 is covered with the primary fixed die plate 77. The outer movable recess portion 201a is a part of the movable die plate 201 recessed toward the movable die plate 201 from the primary fixed attachment plate 73. Thus, the outer movable recess portion 201a is open toward the primary fixed attachment plate 73. The outer movable recess portion 201a is provided outside the first recess portion 77a in an orthogonal direction (Y-direction) that orthogonally intersects with the open/close direction. The outer movable recess portion 201a communicates with the first recess portion 77a.

As shown in FIG. 2, the first supply path portion 83 is provided in the primary fixed attachment plate 73 and the primary fixed fall plate 75 on their central axes. The first supply path portion 83 branches into two parts in the primary fixed die plate 77. The branched first supply path portion 83 is provided along the orthogonal direction in the primary fixed die plate 77. The first supply path portion 83 bends to be provided coaxially with the ejector pin portions 211b and is then provided along the open/close direction in the primary fixed die plate 77. The first supply path portion 83 is provided along the orthogonal direction in the outer movable recess portion 201a of the movable die plate 201, and communicates with the first recess portion 77a.

Thus, the first supply path portion 83 communicates from the outside of the first cavities 81 so that the two first cavities 81 intervene between the two first supply paths 83 in the orthogonal direction.

As shown in FIG. 2, the primary molding die 70 has a first discharge opening portion 83a which is provided in the communication part between the first supply path portion 83 that supplies the first molding material 20a to the first cavity portion 81 and the first cavity portion 81 and which discharges the first molding material 20a toward the first cavity portion 81 from the first supply path portion 83. The first discharge opening portion 83a functions as a gate. The first discharge opening portion 83a communicates with the part of the first cavity portion 81 that forms the first back end face 23 so that no gate mark may be formed in the first optical function surface 29. The first discharge opening portion 83a discharges the first molding material 20a along an inner circumferential surface of the first cavity portion 81 that forms the first outer circumferential function surface 29b when the first discharge opening portion 83a discharges the first molding material 20a toward the first cavity portion 81 from the first supply path portion 83. In other words, in the first discharge opening portion 83a, a discharge direction is along, for example, the inner circumferential surface of the first cavity portion 81.

As shown in FIG. 2, the first discharge opening portion 83a is formed to be smaller than, for example, the first back end face 23. The first discharge opening portion 83a is provided between the first back end opening portion 23a and the ejector pin 211b in the orthogonal direction. Specifically, the first discharge opening portion 83a is provided between the movable insert portion 209 and the first outer circumferential function surface 29b in the orthogonal direction, and is not adjacent to the movable insert portion 209, and is provided, for example, closer to the first outer circumferential function surface 29b than the movable insert portion 209. The discharge direction which is the axial direction of the first discharge opening portion 83a is provided along the axial direction C1 of the first optical element portion 20 which is the open/close direction, and the first discharge opening portion 83a discharges the first molding material 20a along the inner circumferential surface of the first cavity portion 81 that forms the first outer circumferential function surface 29b. For example, one first discharge opening portion 83a is provided for one first cavity portion 81.

[Secondary Molding Die 90]

As shown in FIG. 2, the secondary molding die 90 has, for example, two second cavities portion 101 which are formed between the second fixed die 91 and the movable die 200 in the open/close direction when the movable die 200 is closed relative to the second fixed die 91. The secondary molding die 90 has a second supply path portion 103 which is provided in the second fixed die 91 and the movable die 200 and which functions as a flow path portion where the second molding material 40a flows and which communicates with the second cavities portion 101 and which allows the second molding material 40a to flow to the second cavities portion 101.

As shown in FIG. 5 and FIG. 6, the second cavity portion 101 is formed to mold the composite optical element 10 including the second optical element portion 40 when the movable die 200 is closed relative to the second fixed die 91. The second cavity portion 101 is formed as a space portion which defines the shape of the second optical element portion 40. The second supply path portion 103 is provided so that the second molding material 40a is supplied to two second cavities portion 101 from the second supply path portion 103 at the same time.

As shown in FIG. 4, FIG. 5, and FIG. 6, for secondary molding, the movable die 200 faces the second fixed die 91 in a state where the movable die 200 is holding the first optical element portion 20 molded in the primary molding. In a state where the movable die 200 is closed relative to the second fixed die 91 and where the second cavity portion 101 inside which the first optical element portion 20 is provided is formed, the second molding material 40a is supplied to the second cavity portion 101 from the second supply path portion 103, and fills the second cavity portion 101. Pressure holding and cooling are conducted in a state where the movable die 200 is closed relative to the second fixed die 91, whereby the second optical element portion 40 is molded, the first optical element portion 20 and the second optical element portion 40 are integrated with each other, and the composite optical element 10 is molded.

As shown in FIG. 1A, FIG. 2, FIG. 5, and FIG. 6, the second cavity portion 101 can thus be filled with the second molding material 40a, and molds, with the second molding material 40a, the second optical element portion 40 that is provided on the first optical element portion 20 to cover the first optical function surface 29, and integrates the second optical element portion 40 with the first optical element portion 20, whereby mold the composite optical element 10, in the secondary molding process.

As shown in FIG. 1A, FIG. 2, FIG. 5, and FIG. 6, the second cavity portion 101 has a first space region portion 101a which can mold the second front end face 41 including the second distal function surface 49a that is the first part of the second optical element portion 40, and a second space region portion 101b which can mold the second outer circumferential surface 47 including the second outer circumferential function surface 49b that is the second part of the second optical element portion 40 and which communicates with the first space region portion 101a. The first space region portion 101a is provided in front of the first front end face 21, and the second space region portion 101b is provided beside the first outer circumferential surface 27.

A specific structure of the secondary molding die 90 including the second cavity portion 101 and the second supply path portion 103 is described below.

As shown in FIG. 2, the second fixed die 91 has a secondary fixed attachment plate 93 which is fixed to the fixed platen of the unshown injection molding machine, and a secondary fixed fall plate 95 which is attached to the secondary fixed attachment plate 93 in a state where the secondary fixed fall plate 95 is mounted on the secondary fixed attachment plate 93. The second fixed die 91 has a secondary fixed die plate 97 which is attached to the secondary fixed fall plate 95 in a state where the secondary fixed die plate 97 is mounted on the secondary fixed fall plate 95 and which faces the movable die plate 201 of the movable die 200.

As shown in FIG. 2, the secondary fixed die plate 97 has, for example, two second recess portions 97a to mold the second optical element portions 40. Specifically, the second recess portion 97a defines, in the second optical element portion 40, the second front end face 41 including the second distal function surface 49a, the second outer circumferential surface 47 including the second outer circumferential function surface 49b, and the thick portion of the second optical element portion 40. A shape of an inner circumferential surface of the second recess portion 97a corresponds to a shape of the second front end face 41 and a shape of the second outer circumferential surface 47. A circumference of a bottom portion of the second recess portion 97a is formed as a smooth curved surface. The second recess portion 97a has a projection portion 97b which is provided in the bottom portion of the second recess portion 97a and which molds the second through-hole 45. The projection portion 97b is a part of the secondary fixed die plate 97 that projects toward the movable die plate 201 from the bottom portion of the second recess portion 97a.

As shown in FIG. 2, the second recess portion 97a is a part of the secondary fixed die plate 97 that is recessed toward the secondary fixed attachment plate 93 from the movable die plate 201. Thus, the second recess portion 97a is open toward the movable die plate 201. The second recess portion 97a communicates with the second supply path portion 103.

As shown in FIG. 2, the movable die 200 in the secondary molding die 90 has the same configuration as the movable die 200 in the primary molding die 70, and the movable die 200 is therefore not described in detail here.

As shown in FIG. 8, some of the ejector pin portions 211b are provided outside outer circumferential parts of the first cavity portion 81 and the second cavity portion 101 so that distal end portions of some of the ejector pin portions 211b abut on the first molding material 20a that fills the outer movable recess portion 201a provided in the movable die plate 201 in the secondary molding die 90. The other ejector pin portions 211b are provided inside the first cavity portion 81 and the second cavity portion 101 so that the distal end portions of the other ejector pin portions 211b abut on the second molding material 40a that fills an inner movable recess portion 201b provided in the movable die plate 201 in the secondary molding die 90. Specifically, if the ejector plate unit 211a and the ejector pin portions 211b move in the axial direction of the movable die 200, the distal end portions of some of the ejector pin portions 211b abut on the first molding material 20a that fills the outer movable recess portion 201a, and at the same time, the distal end portions of another ejector pin portions 211b abut on the second molding material 40a that fills an inner movable recess portion 201b. In this state, the ejector pin portions 211b eject the composite optical element 10 including the abutment parts from the movable die 200.

As shown in FIG. 2, the movable die plate 201 and the second recess portions 97a form the second cavity portion 101 when the movable die 200 is closed relative to the second fixed die 91.

As shown in FIG. 2, the movable insert portion 209 is inserted into the second recess portion 97a so that a distal end face of the movable insert portion 209 abuts on the projection portion 97b of the second recess portion 97a when the movable die 200 is closed relative to the second fixed die 91.

As shown in FIG. 2, the second cavity portion 101 is formed by, for example, the second recess portion 97a and the movable die plate 201 when the movable die 200 is closed relative to the second fixed side.

As shown in FIG. 2, the second supply path portion 103 is provided inside the secondary fixed attachment plate 93, the secondary fixed fall plate 95, the secondary fixed die plate 97, and the movable die plate 201, and is formed as a hole provided in these parts. In the movable die plate 201, the second supply path portion 103 is formed when the inner movable recess portion 201b provided in the movable die plate 201 is covered with the secondary fixed die plate 97. The inner movable recess portion 201b is a part of the movable die plate 201 recessed toward the movable die plate 201 from the secondary fixed attachment plate 93. Thus, the inner movable recess portion 201b is open toward the secondary fixed attachment plate 93. The inner movable recess portion 201b is provided inside the second recess portion 97a in the orthogonal direction. The inner movable recess portion 201b is provided between the first optical element portions 20 in the orthogonal direction, and provided along the orthogonal direction. The inner movable recess portion 201b communicates with the second recess portion 97a.

As shown in FIG. 2, the second supply path portion 103 is provided in the secondary fixed attachment plate 93, the secondary fixed fall plate 95, and the secondary fixed die plate 97 on their central axes. The second supply path portion 103 branches into two parts in the inner movable recess portion 201b. The branched second supply path portion 103 communicates with the second recess portion 97a.

Thus, the second supply path portion 103 communicates with the second cavities portion 101 from the inside of the second cavities portion 101 so that the two second supply paths 103 intervene between the two second cavities portion 101 in the orthogonal direction.

As shown in FIG. 2, the secondary molding die 90 has a second discharge opening portion 103a which is provided in the communication part between the second supply path portion 103 that supplies the second molding material 40a to the second cavity portion 101 and the second cavity portion 101 and which discharges the second molding material 40a toward the second cavity portion 101 from the second supply path portion 103. The second discharge opening portion 103a functions as a gate. The second discharge opening portion 103a communicates with the part of the second cavity portion 101 that forms the second back end face 43. Specifically, as shown in FIG. 6, the second discharge opening portion 103a is provided closer to the second outer circumferential function surface 49b than the first outer circumferential function surface 29b in the orthogonal direction. Thus, the second discharge opening portion 103a does not face the first outer circumferential function surface 29b and is provided apart from the first outer circumferential function surface 29b in the orthogonal direction. An edge portion of the second discharge opening portion 103a is provided collinearly with an outer edge portion of the second cavity portion 101 that forms the second outer circumferential function surface 49b. The second discharge opening portion 103a discharges the second molding material 40a along the first outer circumferential function surface 29b when the second discharge opening portion 103a discharges the second molding material 40a toward the second cavity portion 101 from the second supply path portion 103. In other words, the second discharge opening portion 103a communicates with the second space region portion 101b, and a discharge direction in the second discharge opening portion 103a is along the first outer circumferential function surface 29b of the first optical function surface 29. The second discharge opening portion 103a discharges the second molding material 40a so that the second molding material 40a flows along the first outer circumferential function surface 29b in the second cavity portion 101.

As shown in FIG. 6, the second discharge opening portion 103a is formed to be smaller than, for example, the second back end face 43. The second discharge opening portion 103a is provided between the first back end opening portion 23a and the other of the ejector pin portions 211b in the orthogonal direction. Specifically, the second discharge opening portion 103a is provided between the movable insert portion 209 and the second outer circumferential function surface 49b in the orthogonal direction, and is not adjacent to the movable insert portion 209, and is provided, for example, closer to the second outer circumferential function surface 49b than the movable insert portion 209. The discharge direction which is the axial direction of the second discharge opening portion 103a is provided along the axial direction C2 of the second optical element portion 40 which is the open/close direction, and the second discharge opening portion 103a discharges the second molding material 40a along the second outer circumferential function surface 49b. The second discharge opening portion 103a does not discharge the second molding material 40a toward the second outer circumferential function surface 49b. For example, one second discharge opening portion 103a is provided for one second cavity portion 101.

[Functions]

[Primary Molding Process]

As shown in FIG. 2, if the movable die 200 is closed relative to the first fixed die 71, the first cavity portion 81 is formed. The melting first molding material 20a is then supplied to the first cavity portion 81 from the first supply path portion 83, and fills the first cavity portion 81. In this state, pressure holding is conducted for the first molding material 20a at predetermined pressure for a predetermined time, and cooling is further conducted for the first molding material 20a. Consequently, the first optical element portion 20 partly having the first optical function surface 29 is molded with the first molding material 20a.

In this primary molding process, the transparent first optical element portion 20 is molded with the transparent first molding material 20a.

[Transitional Process]

As shown in FIG. 3, the movable die 200 opens relative to the first fixed die 71 in a state where the movable die 200 is holding the first optical element portion 20. At the same time, the first optical element portion 20 is cut off at the PL from a primary unnecessary runner which is the first molding material 20a remaining in the first supply path portion 83 in the primary fixed attachment plate 73, the primary fixed fall plate 75, and the primary fixed die plate 77. The primary unnecessary runner is taken out of the primary molding die 70 by an unshown machine.

As shown in FIG. 4, if the movable platen 300 rotates around the rotation shaft 301, the movable die 200 holding the first optical element portion 20 faces the second fixed die 91, and the movable die 200 which is not holding the first optical element portion 20 faces the first fixed die 71.

[Secondary Molding Process]

As shown in FIG. 5, if the movable die 200 is closed relative to the second fixed die 91, the second cavity portion 101 is formed in a state where the first optical element portion 20 is provided inside the second cavity portion 101. In this state, the distal end face of the movable insert portion 209 abuts on the projection portion 97b of the second recess portion 97a.

In this state, as shown in FIG. 5 and FIG. 6, the second molding material 40a is supplied to the second cavity portion 101 from the second supply path portion 103, and fills the second cavity portion 101. The second molding material 40a fills the second cavity portion 101 to cover the first optical function surface 29 of the first optical element portion 20.

As shown in FIG. 6, in this instance, when the second discharge opening portion 103a discharges the second molding material 40a toward the second cavity portion 101 from the second supply path portion 103, the second discharge opening portion 103a discharges the second molding material 40a along the first outer circumferential function surface 29b of the first optical function surface 29 so that the second molding material 40a flows along the first outer circumferential function surface 29b in the second cavity portion 101. That is, the discharge direction and the flow direction are along the first outer circumferential function surface 29b of the first optical function surface 29, and do not face the first outer circumferential function surface 29b.

Thus, pressure on the first optical function surface 29 from the second molding material 40a is minimal, and the deformation of the first optical function surface 29 resulting from the discharge of the second molding material 40a is minimized. That is, without the influence of the state of the second molding material 40a, for example, the temperature of the second molding material 40a in the second discharge opening portion 103a or the extremely high pressure of the second molding material 40a during the discharge of the second molding material 40a toward the first optical function surface 29 from the second discharge opening portion 103a, the deformation of the first optical function surface 29 is inhibited, and the deterioration of the optical performance of the composite optical element 10 is prevented.

The second discharge opening portion 103a communicates with the part of the second cavity portion 101 that forms the second back end face 43. Thus, the formation of a gate mark in the second optical function surface 49 is prevented.

In a state where the movable die 200 is closed relative to the second fixed die 91, pressure holding is conducted for the second molding material 40a at predetermined pressure for a predetermined time, and cooling is further conducted for the second molding material 40a. Consequently, the second optical element portion 40 provided on the first optical element portion 20 to cover the first optical function surface 29 is molded, and the second optical element portion 40 is fixedly connected to (integrated with) the first optical element portion 20, whereby the composite optical element 10 is molded. The first optical function surface 29 and the inner circumferential surface of the second optical element portion 40 function as joint surfaces which join to the inner circumferential surface of the second optical element portion 40 and which join the first optical element portion 20 to the second optical element portion 40.

In the secondary molding process described above, the primary molding process described above is conducted at the same time when the secondary molding process is conducted.

In the secondary molding process, the colored second optical element portion 40 is molded outside the first optical element portion 20 with the colored second molding material 40a.

[Takeout Process]

As shown in FIG. 7, the movable die 200 opens relative to the second fixed die 91.

Further, as shown in FIG. 8, if the ejector mechanism 211 is driven, the ejector pin portions 211b eject the composite optical element 10 toward the second fixed die 91 from the movable die plate 201. Specifically, the ejector pin portions 211b abut on the solidified first molding material 20a remaining in the outer movable recess portion 201a, and the solidified second molding material 40a remaining in the inner movable recess portion 201b. This first molding material 20a is continuous with the first optical element portion 20 of the composite optical element 10, the second molding material 40a is continuous with the second optical element portion 40 of the composite optical element 10, and the first optical element portion 20 is integrated with the second optical element portion 40. Thus, the composite optical element 10 is taken out without being damaged by the ejector pin portions 211b.

The second molding material 40a remaining in the inner movable recess portion 201b is continuous with and integrated with a secondary unnecessary runner which is the second molding material 40a remaining in the secondary fixed attachment plate 93, the secondary fixed fall plate 95, and the secondary fixed die plate 97. The ejector pin portions 211b take out the secondary unnecessary runner.

After the takeout, the composite optical element 10 is cut off from parts other than the composite optical element 10 such as the secondary unnecessary runner by, for example, a nipper. The composite optical element 10 is then used as a component.

When the movable die 200 opens relative to the second fixed die 91 in the secondary molding die 90, the movable die 200 also opens relative to the first fixed die 71 in the primary molding die 70. The primary molding process and secondary molding process described above are then repeated.

[Effects]

Thus, in the present embodiment, the second discharge opening portion 103a discharges the second molding material 40a along the first outer circumferential function surface 29b of the first optical function surface 29 when the second discharge opening portion 103a discharges the second molding material 40a toward the second cavity portion 101 from the second supply path portion 103. That is, the discharge direction is along the first outer circumferential function surface 29b of the first optical function surface 29.

Therefore, in the present embodiment, pressure on the first optical function surface 29 from the second molding material 40a can be minimal, and the deformation of the first optical function surface 29 resulting from the discharge of the second molding material 40a can be minimized. Thus, in the present embodiment, it is possible to inhibit the deformation of the first optical function surface 29 and prevent the deterioration of the optical performance of the composite optical element 10 without the influence of the state of the second molding material 40a.

In the present embodiment, the second discharge opening portion 103a communicates with the part of the second cavity portion 101 that forms the second back end face 43. Thus, in the present embodiment, the formation of the gate mark in the second optical function surface 49 can be prevented. In the present embodiment, the second discharge opening portion 103a is provided closer to the second outer circumferential function surface 49b of the second optical function surface 49 than the first outer circumferential function surface 29b of the first optical function surface 29 in the orthogonal direction, and is provided apart from the first outer circumferential function surface 29b of the first optical function surface 29. Thus, in the present embodiment, the deformation of the first optical function surface 29 resulting from the discharge of the second molding material 40a can be minimized, and the formation of the gate mark in the first optical function surface 29 can be prevented.

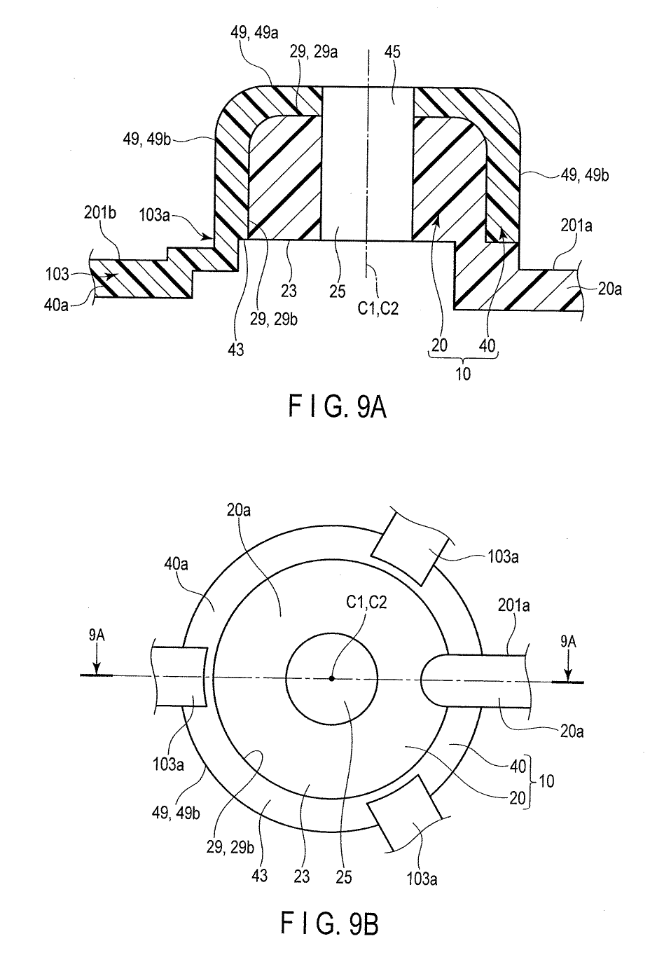

For example, one second discharge opening portion 103a is provided for one second cavity portion 101, but this is not a limitation. As shown in FIG. 9A and FIG. 9B, more than one second discharge opening portion 103a may be provided for one second cavity portion 101. In FIG. 9A and FIG. 9B, the movable die plate 201 and others are not shown for the simplification of diagramatic representation.

In this case, the second discharge opening portions 103a are preferably apart from one another, for example, at equal intervals in a direction around the axis of the second cavity portion 101. Consequently, it is possible to disperse and uniform the pressure on the first optical function surface 29 from the second molding material 40a, and ensure that the deformation of the first optical function surface 29 resulting from the discharge of the second molding material 40a is minimized.

### Second Embodiment

[Configuration]

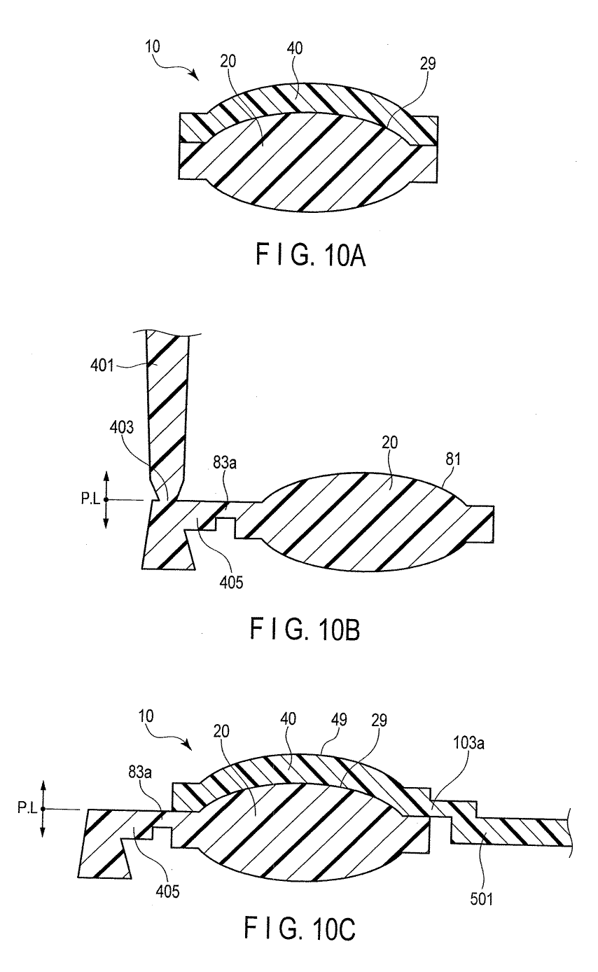

The second embodiment is described with reference to FIG. 10A, FIG. 10B, and FIG. 10C. Some components are not shown in some of the drawings for the clarification of diagramatic representation. Differences between the first embodiment and the second embodiment are only described below.

The composite optical element 10 according to the present embodiment has a function to reduce, for example, chromatic aberration of the lens.

Thus, the refractive index of the first molding material 20a is different from the refractive index of the second molding material 40a. The resin of the first molding material 20a is different from the resin of the second molding material 40a. The second molding material 40a is a transparent resin material.

[Functions]

The functions according to the present embodiment are substantially the same as the functions according to the first embodiment, and are therefore briefly described below.

[Primary Molding Process]

The first molding material 20a fills the first cavity portion 81 from a sub-sprue 401 of the first supply path portion 83 via a pin gate 403, a sub-runner 405, and the first discharge opening portion 83a which functions as a gate. The first optical element portion 20 is then molded.

[Transitional Process]

The movable die 200 opens relative to the first fixed die 71, and at the same time, the sub-runner 405 is cut off from the sub-sprue 401 in the pin gate 403. If the movable platen 300 rotates around the rotation shaft 301 as in the first embodiment, the movable die 200 holding the first optical element portion 20 faces the second fixed die 91 from the first fixed die 71, and the movable die 200 which is not holding the first optical element portion 20 faces the first fixed die 71.

[Secondary Molding Process]

The second discharge opening portion 103a which is a gate and a runner 501 are configured, and the second discharge opening portion 103a discharges the second molding material 40a along the first optical function surface 29. Thus, pressure on the first optical function surface 29 from the second molding material 40a is minimal, and the deformation of the first optical function surface 29 resulting from the discharge of the second molding material 40a is minimized. That is, without the influence of the state of the second molding material 40a, the deformation of the first optical function surface 29 is inhibited, and the deterioration of the optical performance of the composite optical element 10 is prevented.

[Effects]

In the present embodiment, when the first optical element portion 20 and the second optical element portion 40 are transparent and the composite optical element 10 functions as a cemented lens, it is difficult to judge the deformation of the first optical function surface 29 of the first optical element portion 20 by its appearance if the first optical function surface 29 is deformed in the secondary molding process. Therefore, it becomes difficult to inhibit this deformation by, for example, the optimization of molding conditions. Even in this case, according to the embodiment, it is possible to conduct molding while ensuring that the deformation of the first optical function surface 29 is minimized, so that functional deterioration of the composite optical element 10 can be prevented.

The present invention is not completely limited to the embodiments described above, and modifications of components can be made at the stage of carrying out the invention without departing from the spirit thereof. Various inventions can be made by properly combining the components disclosed in the embodiments described above.

What is claimed is:

1. A manufacturing apparatus for a composite optical element, comprising:
a first cavity portion which is configured to be filled with a first molding material, and mold a primary molded article partly having a first optical function surface with the first molding material, in a primary molding process;
a second cavity portion which is configured to be filled with a second molding material, configured to mold, with the second molding material, a secondary molded article that is provided on the primary molded article to cover the first optical function surface, and configured to integrate the secondary molded article with the primary molded article, whereby mold the composite optical element, in a secondary molding process; and
a discharge opening portion which is provided in a communication part between a supply path portion to supply the second molding material to the second cavity portion and the second cavity portion and in which a discharge direction of the second molding material from the supply path portion to the second cavity portion is along the first optical function surface.

2. The manufacturing apparatus for the composite optical element according to claim 1, wherein
the first cavity portion functions as a moldable space portion for the primary molded article so that the primary molded article has a first front end face, a first back end face, a first through-hole which is open in the first front end face and the first back end face and which further pierces through the primary molded article, and a first outer circumferential surface, and so that the first optical function surface has a first distal function surface which is provided in the first front end face and which emits forward light that enters the primary molded article, and a first outer circumferential function surface which is provided in the first outer circumferential surface and which emits sideward the light that enters the primary molded article,
the second cavity comprises
a first space region portion configured to mold a first part of the secondary molded article which is stacked on the first distal function surface so that an opening portion of the first through-hole formed in the first front end face is exposed, and which further emits, to the outside of the secondary molded article, light that enters from the first distal function surface, and
a second space region portion configured to mold a second part of the secondary molded article which is stacked on the first outer circumferential function surface and which further emits, to the outside of the secondary molded article, light that enters from the first outer circumferential function surface, the second space region portion communicating with the first space region portion, and
the discharge opening portion communicates with the second space region portion, and the discharge direction is along the first outer circumferential function surface.

3. A manufacturing method for a composite optical element, comprising
a primary molding process to mold a primary molded article partly having a first optical function surface with a first molding material; and
a secondary molding process to discharge a second molding material along the first optical function surface so that the second molding material to mold a secondary molded article flows along the first optical function surface, mold the secondary molded article that is provided on the primary molded article to cover the first optical function surface, and integrate the secondary molded article with the primary molded article, whereby mold the composite optical element.

4. The manufacturing method for the composite optical element according to claim 3, wherein
the primary molding process is a process to mold the transparent primary molded article with the transparent first molding material, and
the secondary molding process is a process to mold the colored secondary molded article outside the primary molded article with the colored second molding material.

5. The manufacturing method for the composite optical element according to claim 3, wherein
the primary molding process molds the primary molded article so that the primary molded article has a first front end face, a first back end face, a first through-hole which is open in the first front end face and the first back end face and which pierces through the primary molded article, and a first outer circumferential surface and so that the first optical function surface has a first distal function surface which is provided in the first front end face and which emits forward light that enters the primary molded article, and a first outer circumferential function surface which is provided in the first outer circumferential surface and which emits sideward the light that enters the primary molded article,
the secondary molding process molds the secondary molded article so that the secondary molded article has a first part which is stacked on the first distal function surface so that an opening portion of the first through-hole formed in the first front end face is exposed and which further emits, to the outside, light that enters from the first distal function surface, and a second part which is stacked on the first outer circumferential function surface and which further emits, to the outside, light that enters from the first outer circumferential function surface, and
in the secondary molding process, a discharge direction of the second molding material is along the first outer circumferential function surface.
